(19) United States
(12) Patent Application Publication
(10) Pub. No.: US 2024/0133703 A1
(43) Pub. Date: Apr. 25, 2024

(54) USER-DRIVEN TRIP PLANNING SERVER AND METHOD

(71) Applicant: Seung Jae LEE, Seoul (KR)

(72) Inventor: Seung Jae LEE, Seoul (KR)

(21) Appl. No.: 18/547,707

(22) PCT Filed: Dec. 21, 2021
(86) PCT No.: PCT/KR2021/019467

§ 371 Date: Sep. 27, 2023

(30) Foreign Application Priority Data
Feb. 24, 2021 (KR) 10-2021-0024840

(51) Int. Cl. G01C 21/34

(52) U.S. Cl. CPC G01C 21/3484; G01C 21/343

(57) ABSTRACT

Disclosed are a user-driven trip planning server and method. The user-driven trip planning server according to an embodiment of the present disclosure includes: an uploading part configured to receive primary information on a trip destination of which an awareness level is set; a search part configured to search for secondary information on the trip destination uploaded; a category determination part configured to determine a category to which the hip destination belongs, on the basis of the received primary information and the found secondary information; a trip information generation part configured to compare the primary information and the secondary information to generate trip information on the trip destination; and a data management part configured to manage the generated trip information according to the determined category.

### CROSS-REFERENCE TO RELATED APPLICATIONS

This application is a National Stage Entry of International Application No. PCT/KR2021/019467 filed Dec. 21, 2021, which claims priority from Korean Application No. 10-2021-0024840 filed Feb. 24, 2021. The aforementioned applications are incorporated herein by reference in their entireties.

### TECHNICAL FIELD

The present disclosure relates to a user-driven trip planning server and method. More particularly, the present disclosure relates to a user-driven trip planning server and method capable of providing various trip schedules beyond typical trip schedules.

### BACKGROUND ART

Many people travel for a variety of reasons although there are individual differences. With the rapid growth of the global economy and the development of the electronics and telecommunications fields, travelers are expanding their trip destinations beyond domestic travel to countries around the world.

In the case of domestic travel where there are no language barriers, anyone can easily go personal travel without issues. However, in the case of overseas travel where language communication is not smooth, most people take a form of traveling with guides on trip itineraries recommended by travel agencies.

Foreign travel through travel agencies is the most easily accessible form of foreign travel. In general, a travel agency recruits a predetermined number of travelers to proceed with the travel, allowing the travelers to easily travel abroad at low costs. However, group tours come with the inconvenience of having to move together with other group members, and managing individual itineraries is impossible.

Recently, including an application for providing interpretation in each country's language on a mobile device, such as a smartphone, applications for providing various types of information, such as transportation information, accommodation information, and restaurant information for each country, required for travel have been developed. Therefore, it is easy to obtain desired information.

For this reason, travelers with mobile devices have a growing desire to break away from typical foreign travel through travel agencies and to independently decide their trip itineraries and places to visit based on their personal preferences.

Those planning to travel need to acquire information in advance in order to decide their trip itineraries themselves. To this end, most people planning to travel search the Internet for information on trip destinations. There is a vast amount of travel-related information on the Internet, but most of the information is unilaterally posted by travel companies or large portals.

In addition, most trip information is collected and created for the purpose of posting information and is thus created from the one-sided perspective of the information collector, reflecting exaggerated or incorrect information. Such trip information may not reflect changes over time.

As a document in the related art, there is Korean Patent Application Publication No. 10-2019-0093811 (title: METHOD AND SYSTEM FOR PROVIDING TRAVELER-GENERATED CONTENTS AS RECOMMENDED TRAVEL INFORMATION, published 12 Aug. 2019).

### DISCLOSURE

### Technical Problem

Accordingly, the present disclosure has been made keeping in mind the above problems occurring in the related art, and the present disclosure is directed to providing a user-driven trip planning server and method, wherein information on trip destinations is provided from multiple users to construct big data and the big data is used to enable a traveler to plan trip activities.

It is to be understood that technical problems to be solved by the present disclosure are not limited to the aforementioned technical problems and other technical problems which are not mentioned will be apparent from the following description to a person with an ordinary skill in the art to which the present disclosure pertains.

### Technical Solution

According to an embodiment of the present disclosure, there is provided a user-driven trip planning server including: an uploading part configured to receive primary information on a trip destination of which an awareness level is set; a search part configured to search for secondary information on the trip destination uploaded; a category determination part configured to determine a category to which the trip destination belongs, on the basis of the received primary information and the found secondary information; a trip information generation part configured to compare the primary information and the secondary information to generate trip information on the trip destination; and a data management part configured to manage the generated trip information according to the determined category.

Preferably, the trip destination includes a final trip destination, and a plurality of intermediate destinations to pass through on a way to the final trip destination.

In addition, preferably, the search part is configured to search for the secondary information through web crawling.

In addition, preferably, in a case in which the set awareness level is a first level, the category determination part is configured to allow the awareness level to remain at the first level when the number of pieces of data for the secondary information is equal to or less than a reference value, or is configured to change the awareness level to a second level when the number of pieces of data for the secondary information exceeds the reference value.

In addition, preferably, the user-driven trip planning server further includes a user analyzer configured to track location information of a user terminal device uploading the primary information each time the primary information is uploaded, and analyze an uploading pattern of a user.

In addition, preferably, the user-driven trip planning server further includes: a network interface part configured to receive a trip destination search request; and a data management part configured to provide trip information on a trip destination corresponding to the received trip destination search request.

In addition, preferably, the user-driven trip planning server further includes a scheduler configured to plan a trip schedule by matching each activity included in the received trip destination search request with related information.

In addition, preferably, the scheduler is configured to share the planned trip schedule, and recruit participants for the shared trip schedule.

In the meantime, according to another embodiment of the present disclosure, there is provided a user-driven trip planning method including: receiving primary information on a trip destination of which an awareness level is set; searching for secondary information on the trip destination uploaded; determining a category to which the trip destination belongs, on the basis of the received primary information and the found secondary information; comparing the primary information and the secondary information to generate trip information on the trip destination; and managing the generated trip information according to the determined category.

Preferably, the trip destination includes a final trip destination, and a plurality of intermediate destinations to pass through on a way to the final trip destination.

In addition, preferably, in the searching step, the secondary information is found through web crawling.

In addition, preferably, in the determining step, in a case in which the set awareness level is a first level, the awareness level remains at the first level when the number of pieces of data for the secondary information is equal to or less than a reference value, or the awareness level is changed to a second level when the number of pieces of data for the secondary information exceeds the reference value.

In addition, preferably, the user-driven trip planning method further includes tracking location information of a user terminal device uploading the primary information each time the primary information is uploaded, and analyzing an uploading pattern of a user.

In addition, preferably, the user-driven trip planning method further includes: receiving a trip destination search request; and providing trip information on a trip destination corresponding to the received trip destination search request.

In addition, preferably, the user-driven trip planning method further includes planning a trip schedule by matching each activity included in the received trip destination search request with related information.

In addition, preferably, the user-driven trip planning method further includes: sharing the planned trip schedule; and recruiting participants for the shared trip schedule.

### Advantageous Effects

According to the present disclosure, a user-driven trip planning server and method capable of trip planning with reliable trip information by providing trip information verified by experienced people and natives can be provided.

In addition, through a process in which a user can plan trip activities by himself or herself and recruit participants who participate in the trip, the user can plan a user-driven trip by himself or herself and actively participate in the entire process.

Effects that may be obtained from the present disclosure will not be limited to only the above-described effects. In addition, other effects which are not described herein will become apparent to those skilled in the art from the following description.

### BRIEF DESCRIPTION OF THE DRAWINGS

FIG. 1 is a configuration diagram illustrating a network of a user-driven trip planning system according to an exemplary embodiment of the present disclosure.

FIG. 2 is a block diagram illustrating a user-driven trip planning server according to an exemplary embodiment of the present disclosure.

FIG. 3 is a diagram illustrating information on a departure as an example of user-driven trip planning according to an exemplary embodiment of the present disclosure.

FIG. 4 is a diagram illustrating information on a destination as an example of user-driven trip planning according to an exemplary embodiment of the present disclosure.

FIG. 5 is a flowchart illustrating a user-driven trip planning method according to an exemplary embodiment of the present disclosure.

### MODE FOR INVENTION

The above-described objects, other objects, features, and advantages of the present disclosure will be apparent from the following description of exemplary embodiments with reference to the accompanying drawings. However, the present disclosure is not limited to exemplary embodiments described herein and may be embodied in various forms. The embodiments described herein are provided so that this disclosure will be thorough and complete and will fully convey the idea of the present disclosure to those skilled in the art.

In this specification, when an element is referred to as being on another element, it may be directly formed on another element, or a third element may be interposed therebetween. In the drawings, the thicknesses of the elements are exaggerated for effective description of the technical details.

When terms used in the specification, “first”, “second”, etc. are used to describe elements, the elements should not be limited by these terms. These terms have only been used to distinguish one element from another. The embodiments described and exemplified herein include their complementary embodiments.

Also, when it is described that a first element (or constituent) operates or runs on a second element (or constituent), it should be understood that the first element (or constituent) operates or runs in an environment where the second element (or constituent) operates or runs, or the first element (or constituent) operates or runs through direct or indirection interaction with the second element (or constituent).

When it is described that an element, a constituent, an apparatus, or a system includes a constituent configured by a program or software, regardless of explicit mentioning, it should be understood that the element, the constituent, the apparatus, or the system includes another type of hardware (for example, a memory, a CPU, and the like), a program or software (for example, a driver, and the like required to run an operating system or hardware) that is necessary for the program or software to run or operate.

Also, in implementing an element (or a constituent), unless otherwise specially described, it should be understood that the element (or the constituent) may be implemented in any form of software, hardware, or a combination thereof.

Also, the terms used herein are provided to describe the embodiments but not to limit the present disclosure. In the specification, the singular forms include plural forms unless particularly mentioned. The terms “comprises” and/or “comprising” used herein specify the presence of stated elements, but do not preclude the presence or addition of one or more other elements.

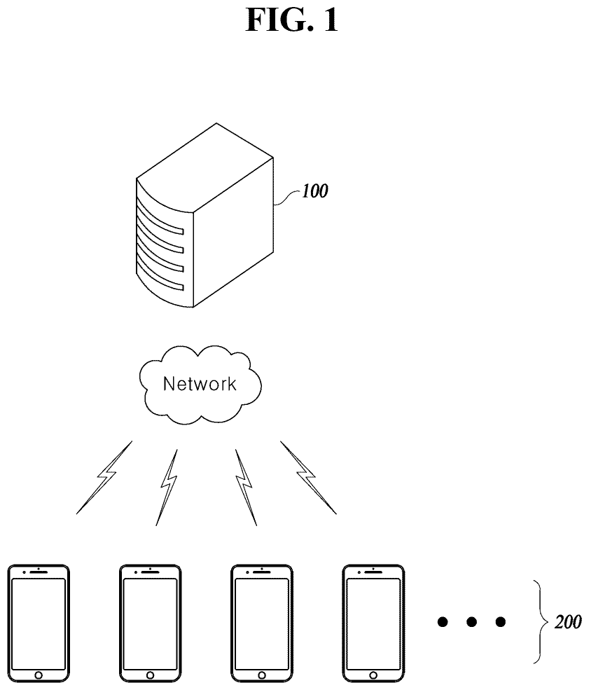

FIG. 1 is a configuration diagram illustrating a network of a user-driven trip planning system according to an exemplary embodiment of the present disclosure.

Referring to FIG. 1, a user-driven trip planning system according to an exemplary embodiment of the present disclosure includes a user-driven trip planning server (hereinafter, referred to as a “trip planning server”) 100, a plurality of user terminal devices 200. Herein, the trip planning server 100 and the plurality of user terminal devices 200 are capable of communication over a network.

The trip planning server 100 is a server that supports a trip-related service to the plurality of user terminal devices 200 accessing the server over the network, and may provide a dedicated application (or app) for providing the service.

The trip planning server 100 may receive primary information uploaded from the plurality of user terminal devices 200, and use the uploaded primary information to search for secondary information. Afterward, the trip planning server 100 compares the primary information and the secondary information to generate trip information, and determines a category according to the trip destination to manage the trip information by category.

In the present embodiment, primary information corresponds to trip information created by each of the users of the plurality of user terminal devices 200, and secondary information corresponds to trip information found by the trip planning server 100 on the Internet.

In addition, a trip destination includes a final trip destination and a plurality of intermediate destinations to pass through on the way to the final trip destination. For example, assuming that from area A, a user visits museum B. Herein, when uploading primary information, the user may include, in the trip destination, museum B as well as restaurants, cafes, bookstores, and souvenir shops that the user visits on the way to museum B from area A.

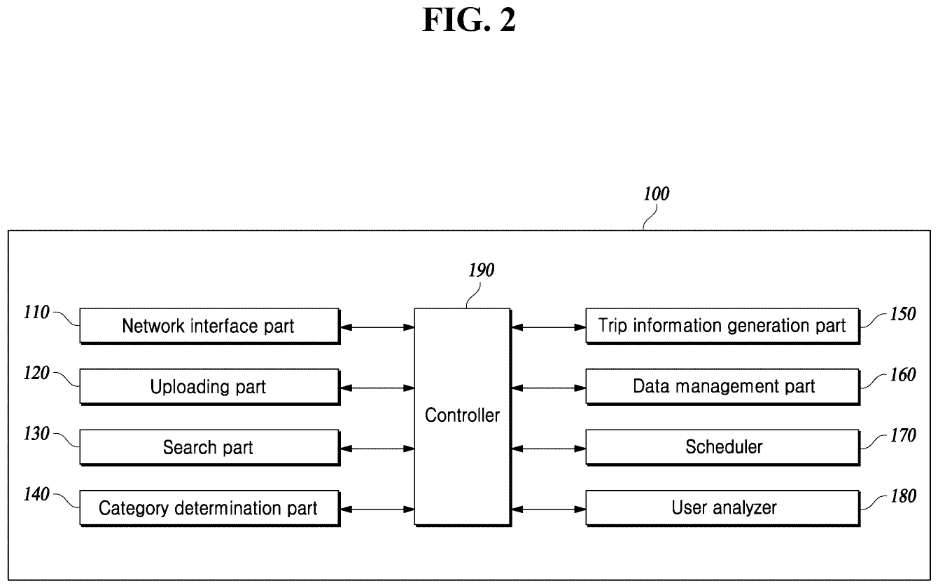

In this way, the primary information created by the user may be uploaded to the trip planning server 100. The trip planning server 100 will be described in more detail later with reference to FIG. 2.

The plurality of user terminal devices 200 are terminal devices capable of network communication and thus accessing the trip planning server 100, may correspond to mobile devices, such as smartphones and tablet PCs, and wired communication device, such as desktops. Due to the character of the trip planning server 100 that aims to receive trip information from a traveler, there is a high possibility that the user terminal devices 200 are mobile devices. However, in some cases, there are users who upload through wired communication after their trip or at their trip destinations.

The places where users who possess the plurality of user terminal devices 200 accessing the trip planning server 100 reside are very diverse. That is, the users may upload trip information through the trip planning server 100 anywhere in the world regardless of their places of residence, or may receive desired trip information from the trip planning server 100.

A user may plan a trip schedule through the trip planning server 100 at a trip planning stage. In addition, the user may share his or her trip schedule planned by himself or herself, with other users through the trip planning server 100. During this sharing process, the user may recruit companions to travel with. After the companions are recruited, the user may adjust the trip schedule with the companions.

In addition, a user may upload information on a trip destination to the trip planning server 100 while he or she is taking a trip, and may set an awareness level that he or she thinks for each trip destination. The information corresponds to primary information. When there are companions on the current trip, the companions visit the same place together, and each user may set their own awareness levels for the same place and may upload primary information. In this case, several users may feel differently about the same place they visit, so various opinions about one place may be collected.

FIG. 2 is a block diagram illustrating a user-driven trip planning server according to an exemplary embodiment of the present disclosure.

Referring to FIG. 2, a trip planning server 100 according to an exemplary embodiment of the present disclosure includes a network interface part 110, an uploading part 120, a search part 130, a category determination part 140, a trip information generation part 150, a data management part 160, a scheduler 170, a user analyzer 180, and a controller 190.

The network interface part 110 supports an interface with a network so that the trip planning server 100 is capable of network communication, and supports network communication with various devices including a user terminal device 200. For example, the network interface part 110 may receive a trip destination search request signal from the user terminal device 200. In the present embodiment, the user terminal device 200 means any one of the plurality of user terminal devices 200 shown in FIG. 1.

The uploading part 120 receives primary information uploaded from the user terminal device 200 through the linkage to the network interface part 110. Herein, the uploaded primary information includes an awareness level set by the user for the trip destination. Herein, the primary information is information uploaded by the user through the user terminal device 200, and is information obtained about the trip destination during or after the trip. The primary information includes objective information as well as the user's subjective review.

The search part 130 searches for secondary information on the trip destination included in the primary information uploaded from the user terminal device 200 through the uploading part 120. In the present embodiment, the search part 130 searches for information, which is called secondary information, on the trip destination through web crawling among numerous pieces of information posted on the Internet.

The category determination part 140 determines, on the basis of the primary information and the secondary information, a category to which the trip destination belongs. According to the present embodiment, categories to which trip destinations belong may include a “well known place” category and an “unknown place” category. The two categories may be distinguished by the amount of information posted on the Internet for each trip destination.

More specifically, when the number of pieces of data for secondary information found for a particular trip destination is equal to or less than a reference value, the category determination part 140 determines that the particular trip destination belongs to the “unknown place” category. Alternatively, when the number of pieces of data for the secondary information exceeds the reference value, the category determination part 140 determines that the particular trip destination belongs to the “well known place” category.

The user uploads primary information on a particular trip destination through the user terminal device 200, and the user sets the awareness level of the trip destination to a first level or a second level. More specifically, when the trip destination is not well known, the user sets the awareness level to the first level. Alternatively, when the trip destination is a well-known and famous place, the user sets the awareness level to the second level.

Afterward, the category determination part 140 performs a verification process on the trip destination of which the awareness level is set to the first level by the user. That is, for the trip destination of which the awareness level is set to the first level, when the number of pieces of data for the secondary information is equal to or less than the reference value, the awareness level remains at the first level. Alternatively, the number of pieces of data for the secondary information exceeds the reference value, the awareness level is changed to the second level. The verification process is performed because there is a risk that the user may determine a place unfamiliar to him or her as being not well known.

The trip information generation part 150 compares the primary information and the secondary information to generate trip information on the trip destination. More specifically, the trip information generation part 150 performs processes such as preventing overlapping content in the primary information and the secondary information and deleting information that is not objectively verified, thereby securing the reliability of information.

The data management part 160 stores the trip information generated by the trip information generation part 150 in a database according to the category determined by the category determination part 140 and manages the database. The database managed by the data management part 160 enables trip information to be turned into big data.

In addition, when a trip destination search request is input from the user terminal device 200, the data management part 160 provides trip information on a trip destination corresponding to the trip destination search request. The trip information managed by the data management part 160 is information that is further verified through a comparison process between the primary information and the secondary information, and is therefore more accurate and reliable information than the trip information obtained by the user through the Internet.

The scheduler 170 plans a trip schedule by matching each activity included in the user's trip destination search request with related information in conjunction with the data management part 160. The operation of the scheduler 170 is merely a means to help the user make a selection, and all decisions regarding the trip activities are made directly by himself or herself.

In addition, the scheduler 170 may share the trip schedule planned at the user's request with other users through a website, and may recruit participants for the shared trip schedule based on the user's selection.

When other users participate in the trip schedule planned by the user, trip expenses may be adjusted or negotiated depending on the number of participants and safety may be ensured compared to traveling alone.

Each time the user uploads primary information, the user analyzer 180 tracks location information of the user terminal device 200 uploading the primary information and analyzes an uploading pattern of the user. For example, when a user continuously uploads primary information on a particular place for a long time, it may be determined that the user is a local resident of the corresponding area. In this case, it may be clearly stated that the place is recommended by a local resident, that is, a native.

The controller 190 controls the overall functions of the trip planning server 100. That is, the controller controls signal input and output between the network interface part 110, the uploading part 120, the search part 130, the category determination part 140, the trip information generation part 150, the data management part 160, the scheduler 170, and the user analyzer 180.

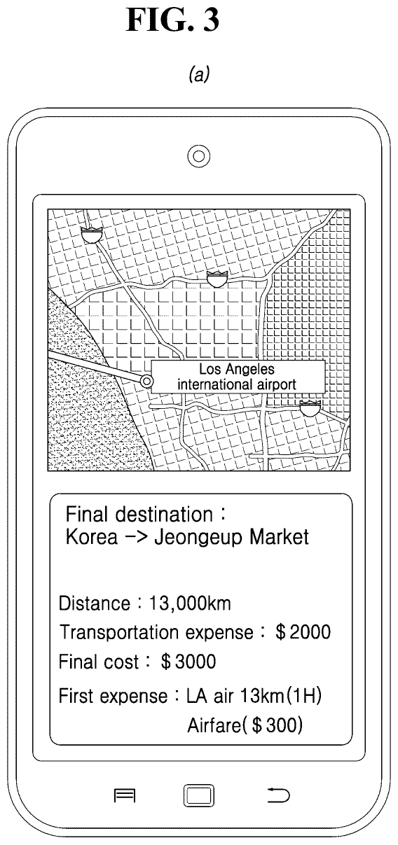

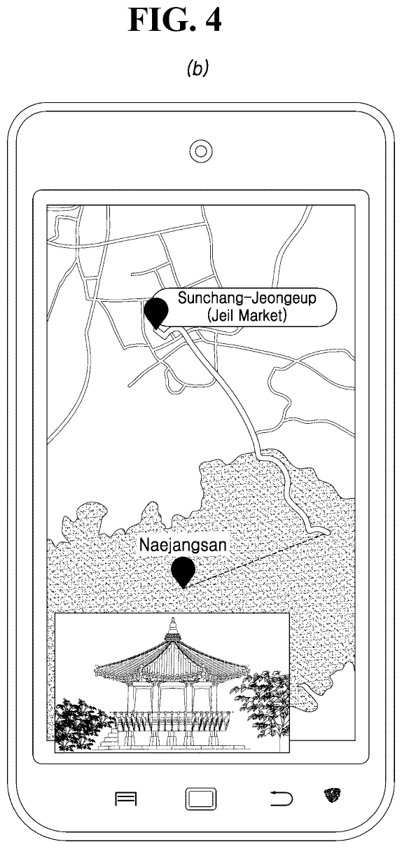

FIGS. 3 and 4 are diagram illustrating examples of user-driven trip planning according to an exemplary embodiment of the present disclosure.

A user accesses a trip planning server 100 through a user terminal device 200 that he or she owns and inputs his or her destination to plan a trip schedule. The present embodiment illustrates a trip schedule planned by a user living in LA, the United States, with Jeongeup market in the Republic of Korea as a destination.

FIG. 3 shows information on a departure as an example of user-driven trip planning according to an exemplary embodiment of the present disclosure. As shown in the drawing, the map showing the current location of a user and the airport where the user will board the plane is displayed to the user for easy recognition. In addition, the planned trip schedule is provided as text information at the bottom of the map.

That is, the displayed information is that the final destination is Jeongeup market in the Republic of Korea, the distance is 13,000 km, and the estimated cost including transportation expense is 3,000 dollars. Additionally, information on layovers for the flight may be included.

FIG. 4 is a diagram illustrating information on a destination as an example of user-driven trip planning according to an exemplary embodiment of the present disclosure. Map information of Jeongeup in the Republic of Korea, the user's destination, is displayed and information on main tourist attractions nearby is also displayed. In particular, it is preferable to separately display the route that the user takes from the airport in the Republic of Korea to Jeongeup.

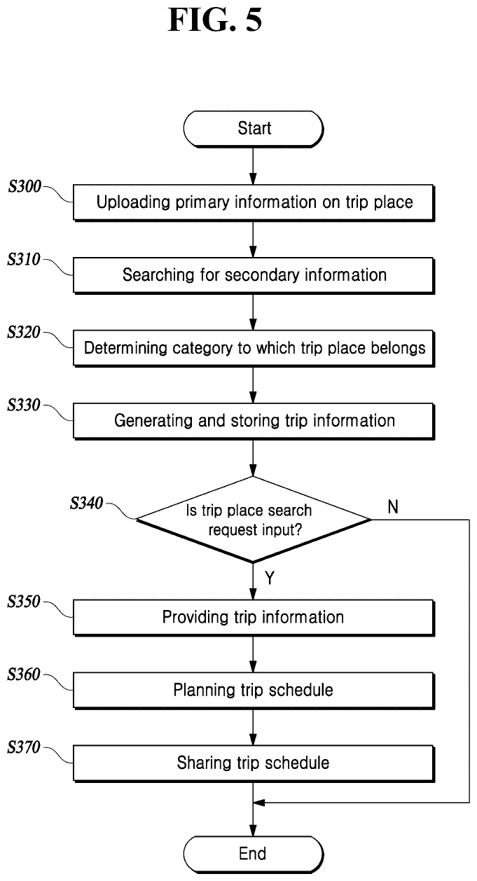

FIG. 5 is a flowchart illustrating a user-driven trip planning method according to an exemplary embodiment of the present disclosure.

Hereinafter, a user-driven trip planning method according to an exemplary embodiment of the present disclosure will be described with reference to FIGS. 1 to 5.

A user uses a user terminal device 200 to access a trip planning server 100 and register primary information on a trip destination, and the trip planning server 100 receives the primary information through an uploading part 120 in step S300. Herein, trip planning may have been started from the trip planning server 100 before the primary information is uploaded.

When the primary information is uploaded by the user, a search part 130 extracts the trip destination included in the primary information and performs web crawling for secondary information on the trip destination in step S310.

A category determination part 140 determines, on the basis of the primary information and the secondary information, a category to which the trip destination belongs. Herein, only when the awareness level set by the user for the trip destination is a first level, the number of pieces of data for the secondary information is compared with a reference value to determine whether to maintain or change the awareness level set by the user in step S320.

A trip information generation part 150 compares the primary information and the secondary information to generate trip information on the trip destination, and a data management part 160 stores the trip information generated by the trip information generation part 150 in step S330.

When a trip destination search request is input from the user terminal device 200 in step S340-Y, the data management part 160 uses pre-stored pieces of trip information to provide the trip information on the trip destination in step S350.

The user determines the trip information provided from the trip planning server 100 through the user terminal device 200. Accordingly, a scheduler 170 plans a schedule that follows trip activities determined by the user in step S360.

The trip schedule planned by the scheduler 170 may be posted on a website operated by the trip planning server 100 and shared with other users, and participants in the trip may be recruited through sharing in step S370.

Through this process, a user can receive trip information verified by experienced people or natives rather than information indiscriminately posted on the Internet, and can plan trip activities according to his or her idea. In addition, the user can upload trip information on a trip destination that he or she has experienced, thus providing useful information to other users.

It will be understood by those skilled in the art that the present disclosure can be embodied in other specific forms without changing the technical idea or essential characteristics of the present disclosure. Therefore, it should be understood that the embodiments described above are illustrative in all aspects as and not restrictive. The scope of the present disclosure is characterized by the appended claims rather than the detailed description described above, and it should be construed that all alterations or modifications derived from the meaning and scope of the appended claims and the equivalents thereof fall within the scope of the present disclosure.

### INDUSTRIAL APPLICABILITY

The present disclosure can provide users with various trip schedules beyond typical trip schedules by receiving trip information verified by experienced people and natives.

1. A user-driven trip planning server, comprising:
an uploading part configured to receive primary information on a trip destination of which an awareness level is set;
a search part configured to search for secondary information on the trip destination uploaded;
a category determination part configured to determine a category to which the trip destination belongs, on the basis of the received primary information and the found secondary information;
a trip information generation part configured to compare the primary information and the secondary information to generate trip information on the trip destination; and
a data management part configured to manage the generated trip information according to the determined category.

2. The user-driven trip planning server of claim 1, wherein the trip destination includes a final trip destination, and a plurality of intermediate destinations to pass through on a way to the final trip destination.

3. The user-driven trip planning server of claim 1, wherein the search part is configured to search for the secondary information through web crawling.

4. The user-driven trip planning server of claim 1, wherein in a case in which the set awareness level is a first level, the category determination part is configured to allow the awareness level to remain at the first level when the number of pieces of data for the secondary information is equal to or less than a reference value, or is configured to change the awareness level to a second level when the number of pieces of data for the secondary information exceeds the reference value.

5. The user-driven trip planning server of claim 1, further comprising:
a user analyzer configured to track location information of a user terminal device uploading the primary information each time the primary information is uploaded, and analyze an uploading pattern of a user.

6. The user-driven trip planning server of claim 1, further comprising:
a network interface part configured to receive a trip destination search request; and
a data management part configured to provide trip information on a trip destination corresponding to the received trip destination search request.

7. The user-driven trip planning server of claim 6, further comprising:
a scheduler configured to plan a trip schedule by matching each activity included in the received trip destination search request with related information.

8. The user-driven trip planning server of claim 7, wherein the scheduler is configured to share the planned trip schedule, and recruit participants for the shared trip schedule.

9. A user-driven trip planning method, comprising:
receiving primary information on a trip destination of which an awareness level is set;
searching for secondary information on the trip destination uploaded;
determining a category to which the trip destination belongs, on the basis of the received primary information and the found secondary information;
comparing the primary information and the secondary information to generate trip information on the trip destination; and
managing the generated trip information according to the determined category.

10. The user-driven trip planning method of claim 9, wherein the trip destination includes a final trip destination, and a plurality of intermediate destinations to pass through on a way to the final trip destination.

11. The user-driven trip planning method of claim 9, wherein in the searching step, the secondary information is found through web crawling.

12. The user-driven trip planning method of claim 9, wherein in the determining step, in a case in which the set awareness level is a first level, the awareness level remains at the first level when the number of pieces of data for the secondary information is equal to or less than a reference value, or the awareness level is changed to a second level when the number of pieces of data for the secondary information exceeds the reference value.

13. The user-driven trip planning method of claim 9, further comprising:
tracking location information of a user terminal device uploading the primary information each time the primary information is uploaded, and analyzing an uploading pattern of a user.

14. The user-driven trip planning method of claim 9, further comprising:
receiving a trip destination search request; and
providing trip information on a trip destination corresponding to the received trip destination search request.

15. The user-driven trip planning method of claim 14, further comprising:
planning a trip schedule by matching each activity included in the received trip destination search request with related information.

16. The user-driven trip planning method of claim 15, further comprising:
sharing the planned trip schedule; and
recruiting participants for the shared trip schedule.
